(19) United States
(12) Patent Application Publication
(10) Pub. No.: US 2005/0209079 A1
(43) Pub. Date: Sep. 22, 2005

(54) Blower for a folder pocket

(75) Inventor: Markus Belmann, Kornwestheim/Pattonville (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/081,478

(22) Filed: Mar. 16, 2005

Related U.S. Application Data
(60) Provisional application No. 60/554,326, filed on Mar. 18, 2004.

(30) Foreign Application Priority Data
Mar. 16, 2004 (DE) 10 2004 012 692.5

(51) Int. Cl. B31F 1/08

(52) U.S. Cl. 493/418

(57) ABSTRACT

A blower for a folder pocket has at least one blower nozzle. The at least one blown air nozzle is configured in such a way that it can be used to produce an air stream which runs substantially in the run-in direction of the folder pocket. Furthermore, a method for assisting sheets running into a folder pocket uses the blown air apparatus at an inlet to a folder pocket for producing an air stream substantially parallel to an incoming direction of the sheets into the folder pocket.

### CROSS-REFERENCE TO RELATED APPLICATION

This application claims the benefit under 35 U.S.C. § 119(e), of copending U.S. Provisional Application No. 60/554,326, filed Mar. 18, 2004; this application also claims the priority, under 35 U.S.C. § 119(a), of German patent application No. 10 2004 012 692.5, filed Mar. 16, 2004; the prior applications are herewith incorporated by reference in their entirety.

### BACKGROUND OF THE INVENTION

Field of the Invention

The invention relates to a blower for a folder pocket having at least one blown air nozzle.

Typically, blowers of this kind are used to provide assistance for the sheet running into a folder pocket, in particular for thin, flexible paper sheets. The most common folder pockets for folders contain an upper and lower frame, which are equipped with guide elements along the sheet running direction. The upper and lower frames are at a distance from each other, so that the incoming sheet, driven by the folder rolls, can run unimpeded into the folder pocket. Fitted transversely with respect to these guide elements is a sheet stop, the stop fingers of which project between the guide elements from the upper into the lower frame. The sheet stop can be set to the desired sheet run-in length.

When the incoming sheet reaches the sheet stop, the front sheet part of the latter is prevented from running further but the rear part of the sheet is guided further. In this way, the sheet folds out at its intended fold and is gripped and folded by the associated folder rolls.

As the front part of the sheet runs into the folder pocket, which is generally at an angle of 45° to 65° with respect to the normal, the following forces act counter to the sheet run: a weight component, which results from the skewed position of the final pocket and the weight per unit area of the sheet, a friction component, which results from the friction between the guide elements, in particular the lower guide element, and the weight per unit area of the sheet, this component includes adhesion forces, and a friction component which results from the electrostatic charging of the paper sheet during the sheet transport and the folding operation.

Now, if the sum of the three components impeding the movement exceeds the bending strength of the sheet to be folded, then the front part of the sheet will not run as far as the sheet stop, instead the sheet will already bend out previously, that is to say will be folded at an unintended point. This effect occurs in particular in the case of lightweight paper sheets.

In order to counter this early folding, in German Utility Model DE 89 06 505 U blower pipes are disposed in the folder pocket in the lower frame of the folder pocket. By blowing in air against the incoming surface of the sheet, the sheet is to some extent lifted slightly and the friction is thus reduced, so that the sheet can run unimpeded as far as the sheet stop.

The blower pipes here have air outlets that are disposed distributed at intervals in the blower pipe longitudinal direction and are aimed toward the lower sheet surface. In one embodiment, air is additionally blown onto the sheet from the upper side, so that the sheet is led as far as the stop between two air cushions. As a result, the friction can be reduced considerably, and the situation in which the sheet is pressed against the other folder pocket housing wall by the blown air on one side is avoided. However, this device has the disadvantage that the position of the sheet can be set only with great difficulty between two air streams that flow onto the sheet from above and below. Therefore, it is not always possible to ensure by this configuration that the sheet actually strikes the stop at the end of the pocket, so that the fold can form at the desired point.

On the subject of air cushions, it is known to use what are known as venturi nozzles in sheet-processing apparatuses, which have a flow component in the sheet running direction in order to guide the sheet and drive it forward in the direction of movement. Apparatuses of this type are disclosed, for example, by published, non-prosecuted German patent applications DE 11 86 473, DE 197 21 390 A1, DE 198 22 059 A1 and DE 101 57 082 A1.

### SUMMARY OF THE INVENTION

It is accordingly an object of the invention to provide a blower for a folder pocket which overcomes the above-mentioned disadvantages of the prior art devices and methods of this general type, which reduces the probability of the occurrence of misfolds which can be brought about by the aforementioned effects. The invention is therefore based on the object of providing a blower with which it is possible to prevent the effect of unintended folding of a sheet running into a folder pocket, in order to ensure that the leading edge of the sheet actually reaches the stop, so that the sheet is folded in at the correct point in the defined manner.

With the foregoing and other objects in view there is provided, in accordance with the invention, a blower for a folder pocket. The blower contains at least one blown air nozzle producing an air stream running substantially in a run-in direction of the folder pocket.

The air stream from the blower according to the invention has the effect of an additional force that drives the sheet in the direction of the stop of the folder pocket. As a result, the force that acts outward on the sheet from the stop is that force which has the effect that the sheet is gripped and folded by the folder rolls at the desired point.

In an advantageous refinement of the blower according to the invention, the blown air nozzle is configured in such a way that the air stream is provided substantially parallel to the direction of movement of an incoming sheet. The air stream, which is provided parallel to the sheet, produces a negative pressure that attracts the sheet by suction in the direction of the blower, so that the sheet is held on an air cushion along the air stream. At the same time, the sheet is lifted off the other side of the folder pocket, so that the frictional resistance is reduced considerably on this side. The blown air nozzle is particularly advantageously a venturi nozzle.

In a further advantageous refinement of the blower according to the invention, the blown air nozzle has a nozzle body, the nozzle body contains a blown air line through which the blown air flows into a nozzle chamber in order to emerge through a slit-like outlet opening. The nozzle chamber is advantageously configured to be substantially semicircular, which permits a good nozzle effect and a uniform blown air distribution along the nozzle opening to be achieved.

In a development of this advantageous refinement of the blower according to the invention, the nozzle chamber is to some extent formed by a nozzle body and to some extent by a separate plate, the separate plate being fixed to the nozzle body, in particular adhesively bonded on. In this way, the hollow space inside the blown air nozzle can be fabricated in a straightforward manner. In addition to bonding, other connecting methods known to those skilled in the art can of course be used.

In a further embodiment of the blower according to the invention, the slit-like outlet opening is to some extent formed by the nozzle body and to some extent by the separate plate. Since the slit-like outlet opening is a substantially rectangular slit, economical production of the slit-like outlet opening is achieved by this configuration. If, for example, the nozzle body is produced in a suitable molding process, for example injection molding from plastic, forms that are unsuitable for injection molding can in particular be produced in a straightforward manner by the separate plate.

In a further advantageous refinement of the blower according to the invention, the blower has a nozzle bar, the nozzle bar contains a plurality of nozzle bodies. The plurality of nozzle bodies are advantageously disposed in a row, the slit-like outlet openings substantially producing an air stream which has substantially the same direction and magnitude for all the blown air nozzles.

In a further advantageous refinement of the blower according to the invention, the nozzle bar is molded in one piece. As a result, both mounting costs and parts costs of the nozzle can be reduced and individual alignment of a plurality of nozzles is likewise dispensed with.

In a further advantageous refinement of the blower according to the intervention, the blower is fitted above the transport path in a folder pocket. As a result, the blown air nozzles aim a flow at the incoming printed sheet from above. As already described, a negative pressure is produced above the sheet as a result, which draws the sheet toward the upper boundary of the folder pocket and, at the same time, drives it forward in the direction of the folder pocket stop. As a result of the negative pressure, at the same time, the sheet is drawn away from the lower folder pocket, which the sheet would principally strike and the greatest frictional forces between sheet and folder pocket boundary would occur, so that the sheet in principle slides without contact through the folder pocket as far as the stop along the air cushion between the upper folder pocket boundary and the sheet.

In a further advantageous refinement of the blower according to the invention, an apparatus for ionizing the blown air is connected to the blower. By use of the ionized air which is blown against the sheets, electrostatic charging of the sheets can be reduced, so that the latter have a lower tendency to adhere to the lateral boundaries of the folder pocket on account of electrostatic forces, which would lead to high frictional forces.

In a further advantageous refinement of the blower according to the invention, a plurality of blown air nozzles are disposed along a folder pocket transversely with respect to the incoming direction.

The invention also relates to a method for assisting sheets running into a folder pocket. The method includes positioning the blown air apparatus at the inlet to a folder pocket and producing an air stream substantially parallel to the incoming direction of the sheets into the folder pocket.

In addition, the invention relates to a folder pocket having a corresponding blown air apparatus and a folder having such a folder pocket.

Other features which are considered as characteristic for the invention are set forth in the appended claims.

Although the invention is illustrated and described herein as embodied in a blower for a folder pocket, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration showing the folding principle of a pocket folder;

FIG. 2 is a diagrammatic illustration showing forces that act in order to form the fold on the sheet in the folder pocket and the vectorial representation of these forces;

FIG. 3 is a diagrammatic illustration of a folder pocket having the blower according to the invention; and

FIG. 4 is a diagrammatic, perspective view of an embodiment having a plurality of blown air nozzles disposed beside one another.

### DESCRIPTION OF THE PREFERRED EMBODIMENTS

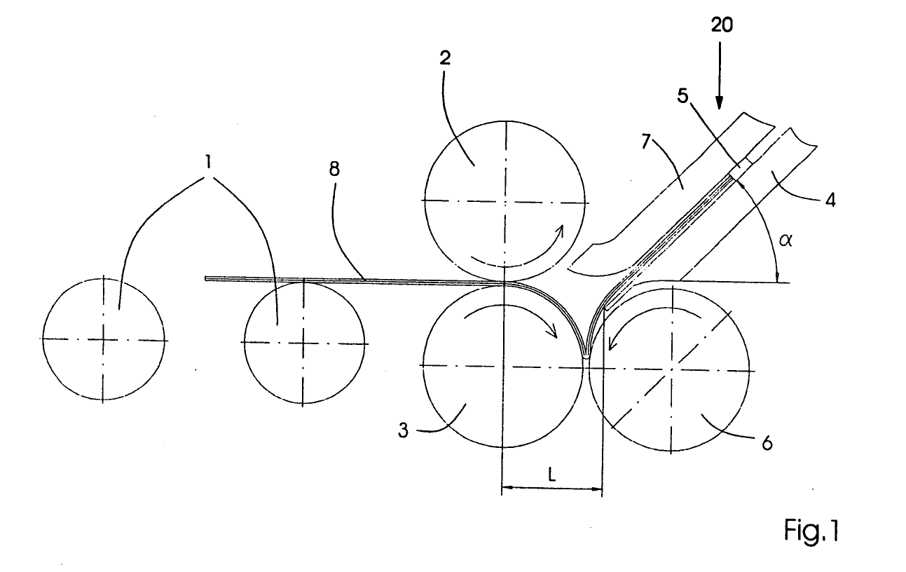

Referring now to the figures of the drawing in detail and first, particularly, to FIG. 1 thereof, there is shown a sheet 8 which is just being folded between the folder rolls 3, 6. Previously, the sheet has been supplied by the conveyor rolls 1 to an upper feed roll 2 and the lower feed roll 3, which operates simultaneously as the folder rolls 3. The leading edge of the incoming sheet 8 tends to run downward on account of the force of gravity G, but after a distance L is led upward into a folder pocket 20 by a projection from the folder pocket underside 4. The folder pocket 20 is at an angle with respect to the horizontal. The sheet 8 slides along the folder pocket underside 4 and folder pocket upper side 7 onto the folder pocket 20, driven by the upper feed roll 2 and the lower feed roll 3, as far as a stop 5. When the sheet 8 has reached the stop 5, the feed rolls 2, 3 continue to push the sheet, so that an end compression forms in the end compression space between the three rolls 2, 3, 6, sags and is ultimately gripped by the pair of folder rolls 3, 6.

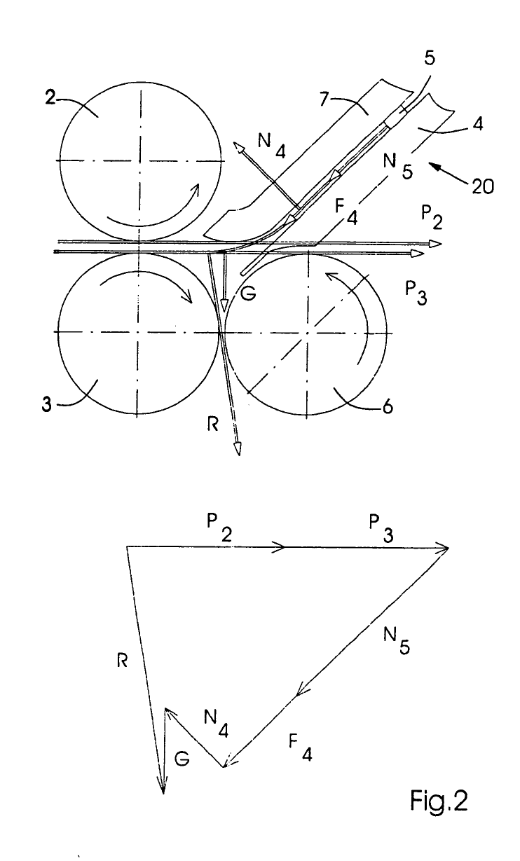

FIG. 2 shows the forces that act on the sheet 8 in the process. These are composed of the weight G, the frictional force F₄ which occurs between the sheet 8 and the folder pocket underside 4 and depends in particular on the material characteristics of the sheet and the electrostatic charge on the latter, a normal force N₄ which acts on the sheet in the folder pocket 20 and in particular depends on the angle of the folder pocket 20, and the opposing force on the stop N₅. The opposing force N₅ increases with the thrust forces P₂, P₃ of the feed rolls 2, 3. These forces result in a resultant R, the magnitude and direction of which accordingly depends on the aforementioned forces.

The resistance of the sheet 8 to folding decreases and the weight G of the part of the sheet between the folder rolls 2, 3 and the folder pocket 20 increases as the distance L increases. For this reason, folders typically have a possible way of offsetting the pocket position. As the thickness and density of the paper increase, the distance L is reduced in order to reduce the sheet resistance, but in the case of thin and weak paper, the distance L is reduced in order that the sheet does not sag and crumple but runs normally into the pocket. If the angle of inclination of the folder pocket 20 is increased, the resistances on the pocket wall N₄ and the frictional force F₄ increase. Consequently, the conditions of the introduction of the sheet into the pocket become worse and the value of the resultant R is reduced. If the angle of inclination of the folder pocket 20 is reduced, the values of the forces from the feed rolls P₂, P₃ and the opposing force on the stop N₅ which are required in order to achieve the necessary value of the resultant R required to start the formation of a fold on the sheet increase sharply. In the process, the deformations of the sheet 8 in the folder pocket 20 increase and the position at which the folded edge of the sheet 8 is formed becomes imprecise. As a result, the folding accuracy decreases.

In addition, the condition of the surface of the folder pocket 20 is very important, since the level of friction of the paper on the pocket depends on this and, consequently, so does the value of the frictional force F₄. The angle of inclination of the folder pocket 20 is chosen by computation such that, first, the resistance during the introduction of the sheet 8 into the folder pocket 20 is not too high and, second, the distribution of the forces F₄, G, N₄, N₅, P₂, P₃ is as beneficial as possible. The most common are angles of inclination of 30° to 45°.

If a sheet 8 of particularly thin and weak or statically charged paper runs into the folder pocket 20, the angle of the resultant R which is required to start the formation of a fold on the sheet 8 is reached earlier than the time at which the sheet 8 reaches the stop 5. As a result, the end compression is formed too early and the formation of the folded edge takes place at the wrong point. In order to assist the entry of the sheet 8 into the folder pocket 20, there are two possibilities, first to reduce the level of friction of the paper on the folder pocket underside 4, and second to produce an additional force which acts in the running direction on the sheet 8 in the folder pocket 20. Both of these possibilities can be achieved by use of a venturi effect.

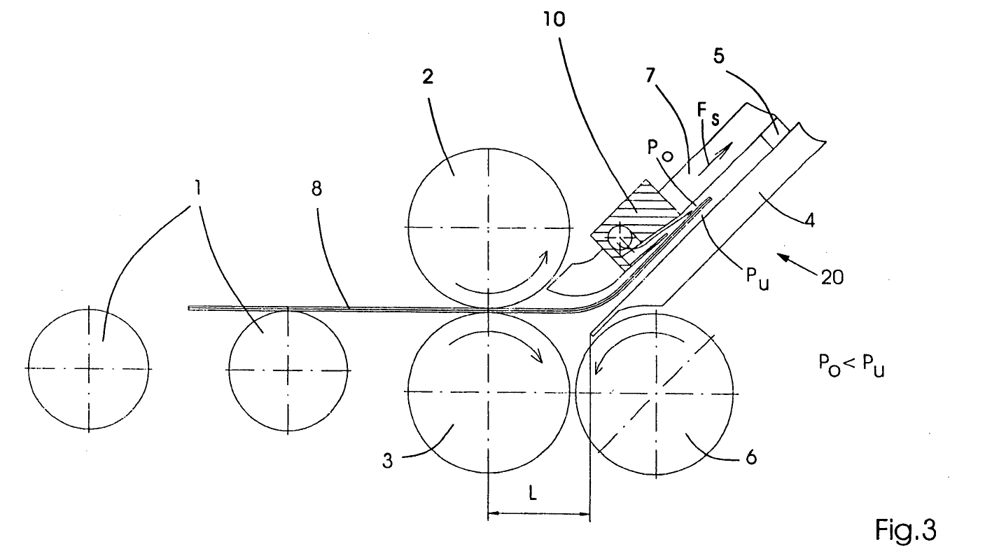

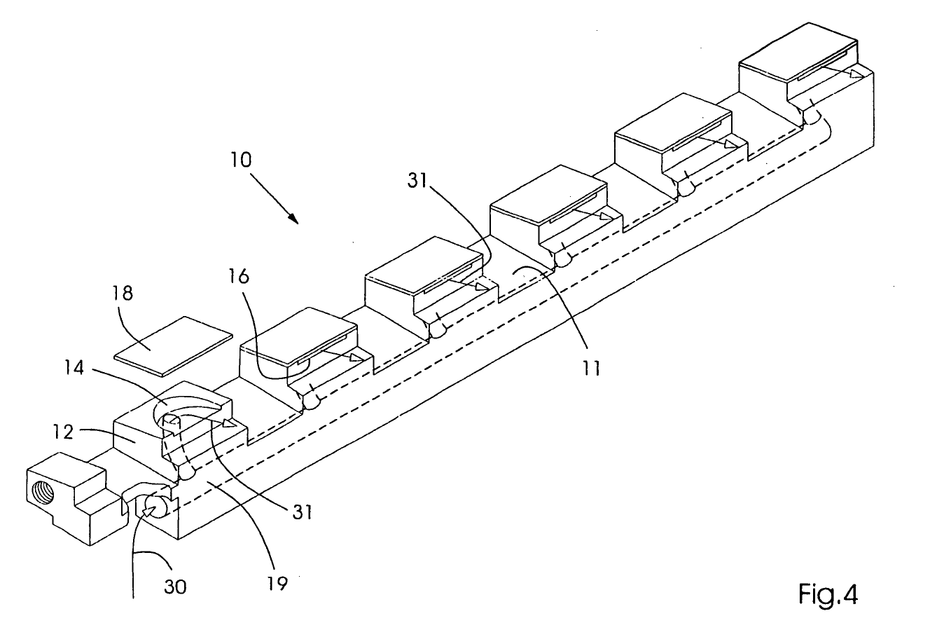

As FIG. 3 shows, there is such a venturi nozzle 10 above the sheet 8, on the upper side 7 of the folder pocket, and produces an air stream 31 which is substantially parallel to the sheet running direction (see FIG. 4). First of all, a force Fₛ that drives the sheet 8 in the direction of the stop 5 is produced by the air stream 31 as a result of friction with the upper side of the sheet. Second, the air stream 31 above the sheet 8 produces a pressure Pₒ that is lower than the air pressure underneath the sheet Pᵤ. This negative pressure above the sheet Pₒ produces a suction that draws the sheet 8 in the direction of the folder pocket upper side 7. However, the sheet 8 is simultaneously prevented by the air stream 31 from reaching the folder pocket upper side 7. Accordingly, an air cushion therefore forms between the folder pocket upper side 7 and sheet 8, as a result of the air stream 31. Therefore the sheet 8 no longer comes into contact with the folder pocket underside 4, so that the frictional force F₄ at this point is reduced considerably.

Advantageously, a plurality of venturi nozzles 10 are disposed along the inlet edge of the folder pocket upper side 7, so that the air cushion acts uniformly over the sheet width. Such a configuration of a plurality of blown air nozzles 10 is shown in FIG. 4. Shown there is a nozzle bar 11 which, for example, can be molded in one piece. The nozzle bar 11 contains a plurality of nozzle bodies 12, which are disposed beside one another in an identical structure and have a common blown air feed line 19 through which air is blown in. Disposed in the nozzle body 12 is a semicircular nozzle chamber 14. The height of the semicircular nozzle chamber 14 decreases toward the outlet opening 16. In the bottom of the nozzle chamber 14, a connection to the blown air feed line 19 is provided. A cover for the nozzle chamber 14 is formed by a separate plate 18, which is fixed to the nozzle body 12 by suitable fixing, for example by an adhesive. In this case, the separate plate 18 simultaneously also forms part of the outlet opening 16 through which the air stream 31 emerges. Such a nozzle bar 11 is advantageously inserted into every folder pocket 20 of a folder. However, it is also conceivable, for example, to equip only the first folder pocket with such a blown air apparatus 10. It is likewise conceivable to provide individual nozzle bodies 12 beside one another. It is likewise conceivable to configure the outermost blown air nozzles in such a way that they have an additional laterally acting force component, which can additionally stabilize the sheet 8.

1. A blower for a folder pocket, comprising:
at least one blown air nozzle producing an air stream running substantially in a run-in direction of the folder pocket.

2. The blower according to claim 1, wherein said blown air nozzle is configured such that the air stream is provided substantially parallel to a direction of movement of an incoming sheet.

3. The blower according to claim 1, wherein said blown air nozzle is a venturi nozzle.

4. The blower according to claim 1, wherein said blown air nozzle has a nozzle body with a nozzle chamber formed therein and a slit-like outlet opening formed therein, said nozzle body further containing a blown air feed line through which blown air flows into said nozzle chamber for emerging through said slit-like outlet opening.

5. The blower according to claim 4, wherein said nozzle chamber is configured to be substantially semicircular.

6. The blower according to claim 4, further comprising a separate plate, said nozzle chamber is to some extent formed by said nozzle body and to some extent by said separate plate, said separate plate being fixed to said nozzle body.

7. The blower according to claim 6, wherein said slit-like outlet opening is to some extent formed by said nozzle body and to some extent by said separate plate.

8. The blower according to claim 4,
wherein said nozzle body is one of a plurality of nozzle bodies; and
further comprising a nozzle bar containing said plurality of said nozzle bodies.

9. The blower according to claim 8, wherein said nozzle bar is molded in one piece.

10. The blower according to claim 1, wherein the blower is configured for fitting above a transport path of the folder pocket.

11. The blower according to claim 1, further comprising an apparatus for ionizing the air stream, said apparatus is connected to said blown air nozzle.

12. The blower according to claim 1, wherein said blown air nozzle is one of a plurality of blown air nozzles disposed along the folder pocket transversely with respect to an incoming direction.

13. The blower according to claim 6, wherein said separate plate is adhesively bonded to said nozzle body.

14. A method for assisting sheets running into a folder pocket, which comprises the steps of:
providing a blown air apparatus at an inlet to the folder pocket; and
producing an air stream substantially parallel to an incoming direction of the sheets into the folder pocket.

15. A folder pocket, comprising:
a blower having at least one blown air nozzle producing an air stream running substantially in a run-in direction of the folder pocket.

16. A folder, comprising:
a folder pocket containing a blower having at least one blown air nozzle producing an air stream running substantially in a run-in direction of the folder pocket.
